(19) United States
(12) Patent Application Publication
(10) Pub. No.: US 2020/0035101 A1
(43) Pub. Date: Jan. 30, 2020

(54) SYSTEMS AND METHODS FOR ALLOCATING VEHICLE PARKING SPACES

(71) Applicant: Walmart Apollo, LLC, Bentonville, AR (US)

(72) Inventors: Cristy Crane Brooks, Cassville, MO (US); Greg A. Bryan, Centerton, AR (US); Benjamin D. Enssle, Bella Vista, AR (US); David Blair Brightwell, Bentonville, AR (US); Jeffrey Kerbs, Bentonville, AR (US); Jesse Lee Eaton, Springdale, AR (US); Jeremy Tingler, Bentonville, AR (US); Steven Lewis, Bentonville, AR (US)

(21) Appl. No.: 16/521,994

(22) Filed: Jul. 25, 2019

Related U.S. Application Data
(60) Provisional application No. 62/711,201, filed on Jul. 27, 2018.
(60) Provisional application No. 62/758,066, filed on Nov. 9, 2018.

(51) Int. Cl. G08G 1/14; G06Q 10/02

(52) U.S. Cl. CPC G08G 1/143; G06Q 2240/00; G06Q 10/02

(57) ABSTRACT

A parking space allocation system comprises a special-purpose allocation computer that communicates with at least one electronic sensor to identify a state of a plurality of parking spaces, including a determination whether the parking spaces are occupied or unoccupied and that automatically modifies an unoccupied parking space to be visually identifiable for authorized use by a vehicle or vehicle occupant; and a special-purpose authorization computer that authenticates the vehicle or vehicle occupant for the authorized use of the unoccupied parking space by the vehicle. The special-purpose allocation computer further allocates the unoccupied parking space to the authenticated vehicle or vehicle occupant according to a predetermined criterion that requires the unoccupied parking space to be in proximity to or a predetermined distance from a destination of interest by the vehicle occupant.

### RELATED APPLICATIONS

This application claims the benefit of U.S. Provisional Patent Application No. 62/711,201 filed Jul. 27, 2018 entitled “System and Method for Allocating Vehicle Parking Spaces” and U.S. Provisional Patent Application No. 62/758,066 filed Nov. 9, 2018 entitled “System and Method for Allocating Vehicle Parking Spaces” the content of each of which is incorporated by reference herein in its entirety.

### TECHNICAL FIELD

The technical field generally relates to parking management. More particularly, the technical field relates to a dynamic and automated allocation of parking spaces to vehicles for consumers.

### BACKGROUND

Retail establishments such as large stores, supermarkets, and shopping malls often face parking shortages, especially during peak hours, weekends, and holiday seasons. In some cases, parking spaces identified for handicapped persons often remain vacant, even though the other parking spaces are at capacity. In other cases, handicap parking spaces are in short supply. In addition, parking spaces allocated for special reasons, such as “the employee of the week,” frequent shoppers, or other persons of interest may be prone to unauthorized use if an allocated parking space is inadequately marked, monitored, otherwise lacking enforcement. Local ordinances or government-enacted laws may require a minimum number of handicap parking spots, so any allocation of parking spaces must be constructed to avoid any violation of such lows or ordinances.

### BRIEF SUMMARY

In one aspect, a parking space allocation system comprises a special-purpose allocation computer that communicates with at least one electronic sensor to identify a state of a plurality of parking spaces, including a determination whether the parking spaces are occupied or unoccupied; a light emitting device that is controlled by the special-purpose allocation computer to automatically modify an unoccupied parking space to be visually identifiable for authorized use by a vehicle or vehicle occupant; and a special-purpose authorization computer that authenticates the vehicle or vehicle occupant for the authorized use of the unoccupied parking space by the vehicle, wherein the special-purpose allocation computer further generates and outputs a signal that changes a state of the parking spaces by allocating the unoccupied parking space to the authenticated vehicle or vehicle occupant according to a predetermined criterion that requires the unoccupied parking space to be in proximity to or a predetermined distance from a destination of interest by the vehicle occupant.

In another aspect, a parking space allocation system comprises a plurality of sensors that monitor a plurality of parking spaces to determine an occupancy of at least one of the parking spaces; an image projection device that changes a state of the at least one of the parking spaces to a reserved state for use by a predetermined vehicle; and a special-purpose allocation computer that controls the image projection device to change the state of the at least one of the parking spaces by determining a match between the predetermined vehicle and a location of the parking space and by determining whether an occupancy percentage of the plurality of parking spaces is greater than a threshold value.

In another aspect, a computer program product comprises a computer readable hardware storage device storing a computer readable program code, the computer readable program code comprising an algorithm that when executed by a computer processor of a computer system implements a method for automatically allocating parking spaces, comprising: monitoring the number of parking spaces to determine an availability of the parking spaces; identifying a parking space as available for a vehicle authorized to occupy the parking space; automatically modifying a parking space to match the vehicle or the needs of an occupant of the vehicle; applying video analytics to determine whether a vehicle is occupying one of the handicap parking spaces; providing the occupant of the vehicle with access from the identified parking space to a retail store in proximity of the parking space; and tracking the occupant to determine when the parking space will be available for a next vehicle.

In another aspect, a parking space analytics system comprises a special-purpose computer processor that processes a combination of historical data regarding prior parking space use, current status data, and future parking space need data to determine if a parking lot of interest has a number of unoccupied parking spaces that is at or greater than a threshold number of unoccupied parking spaces; and a special-purpose allocation computer that controls an indicator at the unoccupied parking spaces in response to a result generated by the special-purpose computer processor of the processed combination of historical data, current status data, and future parking space need data to automatically modify an unoccupied parking spaces to be visually identifiable for authorized use by a vehicle or vehicle occupant.

### BRIEF DESCRIPTION OF THE DRAWINGS

The above and further aspects of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 depicts a parking lot in which embodiments of the present inventive concepts are practiced.

FIG. 2 depicts a parking lot in which other embodiments of the present inventive concepts are practiced.

FIG. 3 depicts a schematic diagram of a special-purpose allocation computer and a special-purpose authorization computer of the parking space allocation system of FIGS. 1 and 2.

FIG. 4 depicts a flow diagram of a method for allocating a parking space for a vehicle by adjusting a number of parking spaces, in accordance with some embodiments.

FIG. 5 depicts a flow diagram of a method for adjusting a number of parking spaces, in accordance with some embodiments.

FIG. 6 is a block diagram of a system for determining handicap parking space availability, in accordance with some embodiments.

FIG. 7 depicts a flow diagram of a method for predicting a parking space requirement, in accordance with some embodiments.

FIG. 8 depicts a flow diagram of a method for allocating parking space for a vehicle, in accordance with some embodiments.

### DETAILED DESCRIPTION

In brief overview, embodiments of the present inventive concepts include a system and method for dynamically adjusting the number of handicap or other reserved parking spaces at a store based on predetermined criteria and usage requirements. A number of parking spaces at a parking lot marked and allocated for use by handicapped persons or otherwise reserved for predetermined vehicle users may be dynamically increased by automatically displaying a handicap sign or other indicator that a particular parking space is reserved, or dynamically decreased by removing such indicators from parking spaces according to a determination whether additional reserved parking spaces are required. As parking spaces approach full occupancy, the system can automatically change the status of adjacent spaces to “reserved spaces,” for example, by projecting an image of a handicap parking sign or symbol onto a surface of the available parking space, displaying the handicap logo on an e-paper display at the parking space, or presenting the handicap information at a predetermined parking space by another technique that notifies other vehicle drivers that the marked parking space is not available but only to a vehicle that satisfies the criteria set forth by the displayed information, for example, only handicapped vehicle occupants may be permitted to use the parking space. This can also apply to football stadiums, schools, hospitals, or anywhere else that has a parking lot. In some embodiments, spaces can be allocated in a fire lane or high occupancy vehicle (HOV) lane, sidewalk, or other location where handicap parking signs or other restrictions may be displayed.

In some embodiments, the system can authenticate a user of a parking space allocated for handicapped persons, special users such as very important persons (VIPs), employees of the week, and so on by detecting machine-readable tags, parking stickers, or the like displayed on a windshield or other location of the vehicle itself or user of the vehicle and processing data collected from these identifying objects (tags, stickers, etc.) to confirm the identity or otherwise authenticate the vehicle and/or user. In some embodiments, the system can automatically monitor a vehicle moving in a parking lot and automatically assign a space to the vehicle by illuminating or otherwise marking the space for occupancy by the vehicle. The system can also provide other features for a person or vehicle authorized for occupying an allocated space, such as ensuring that an assigned space is provided for a user who plans to shop at a store proximal the allocated space, and/or to make available a store-provided vehicle such as a motor scooter, wheelchair, or the like to be present at the allocated space in a “just in time” manner, i.e., arriving concurrently with the vehicle occupying the parking space.

In other embodiments, a special-purpose computer processor performs parking space analytics by processing a combination of historical data regarding prior parking space use, current status data, and future parking space need data to determine if a parking lot of interest has a number of unoccupied parking spaces that is at or greater than a threshold number of unoccupied parking spaces. A result generated by the special-purpose computer processor can be used to automatically modify unoccupied parking spaces to be visually identifiable for authorized use by a vehicle or vehicle occupant. In some embodiments, the indicator includes an electronic sign, wherein the special-purpose computer processor determines an occupancy status of the parking lot of interest, and compares the occupancy status to a history of occupancy of the parking lot of interest according to predetermined criteria. The comparison result can be used to activate the electronic sign in response to a determination from the comparison that additional parking spaces are required to an increase the number of unoccupied parking spaces to be at or greater than the threshold number of unoccupied parking spaces, or used to change an occupancy state of one or more predetermined parking spaces according to a determination of store activity at a region of a retail establishment proximal the predetermined parking spaces.

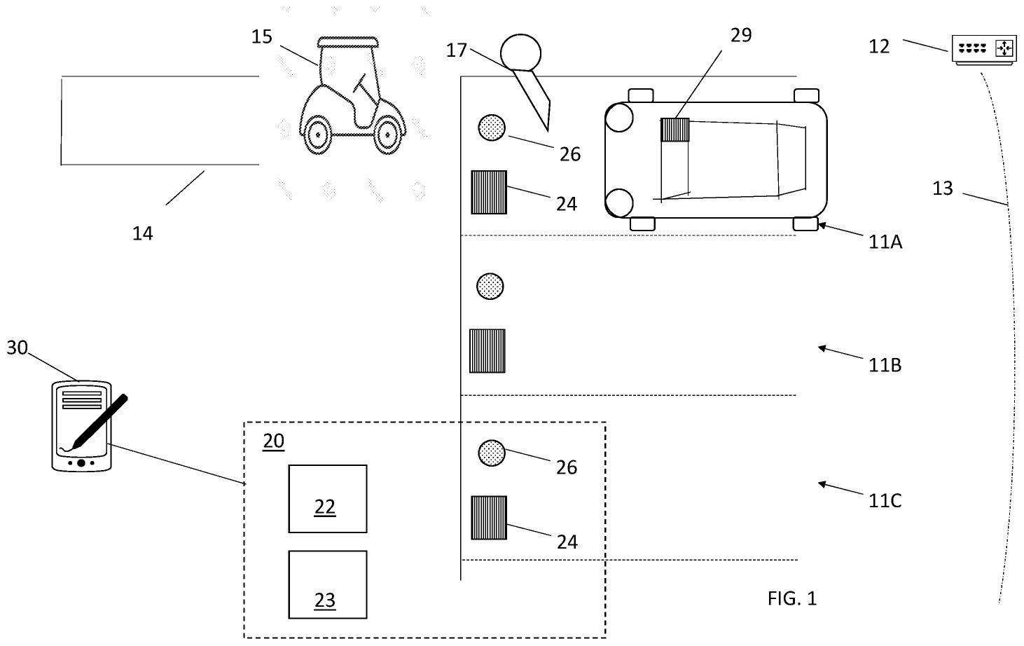

Referring now to FIG. 1, a parking lot 10 may include a predetermined arrangement of parking spaces 11, one or more of which may be modified and/or use thereof enforced by embodiments of the present invention. A parking space allocation system 20 may control the manner in which the parking spaces 11, also referred to as parking spots, are dynamically identified, allocated, configured, or otherwise visually presented to vehicle drivers interested in using the parking spaces 11 for temporarily parking their vehicles. In doing so, the parking space allocation system 20 may include but is not limited to some or all of a special-purpose allocation computer 22, a special-purpose authorization computer 23, an image projection device 24, and a plurality of sensors 26 constructed and arranged as electronic sensors or the like for monitoring the parking spaces 11 for the presence of a vehicle, confirming an identity of a driver, or other detection-related functions.

In some embodiments, the sensors 26 provide data collected from monitoring one or more parking spaces 11 to the special-purpose allocation computer 22 and/or authorization computer 23 for processing, for example, to determine whether the monitored parking space or spaces 11 are occupied by a vehicle and/or whether the vehicle in the parking space 11 is authorized to use the parking space 11. In some embodiments, at least one sensor 26 can be an optical sensor or the like that is located in or proximal to a parking space 11 of interest in order to detect the presence of a vehicle in the parking space, to identify the vehicle and/or occupant(s) in the vehicle, to detect objects on the vehicle such as windshield stickers identifying the vehicle as transporting handicapped occupants, and so on. In some embodiments, the sensors 26 can include Internet of Things (IoT) processing features so the sensors 26 can exchange IoT data signals with remote computing devices.

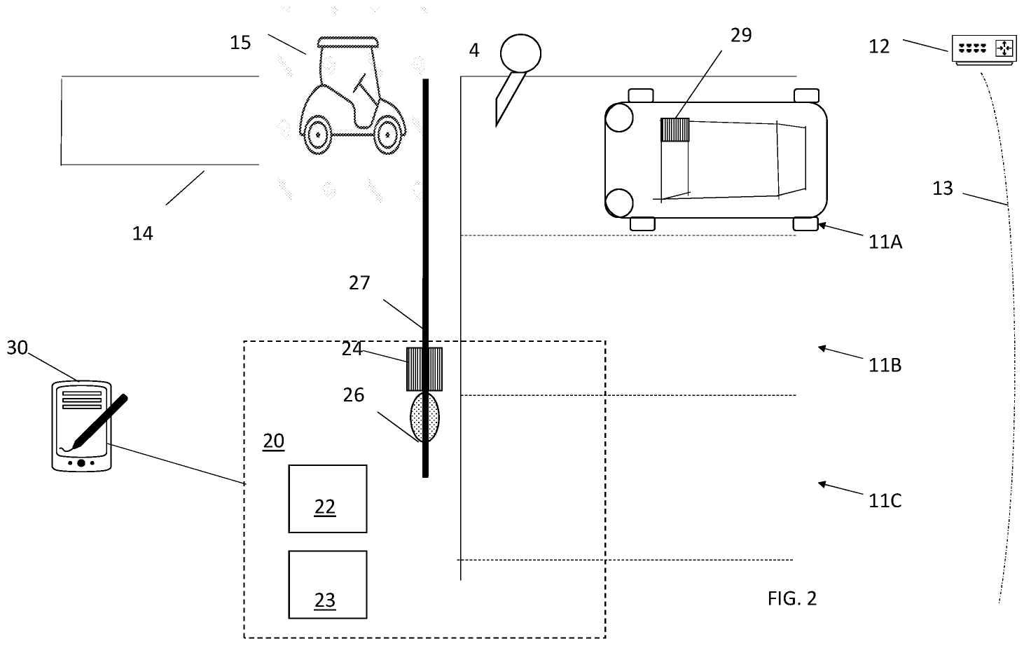

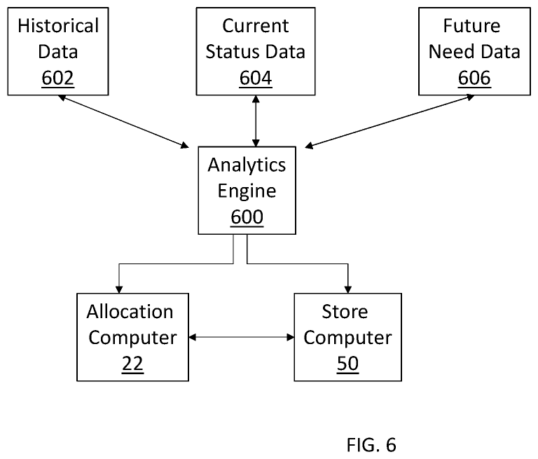

In some embodiments, as shown in FIG. 1, each parking space 11 has at least one sensor 26. In other embodiments, for example, shown in FIG. 2, a sensor, e.g., a camera, LIDAR apparatus, and so on, may be arranged at or near the parking lot for the surveillance of multiple parking spaces for 11 in real-time. When filming parking spaces, images can be collected of vehicles, license plates, occupants, and so on for image recognition processing, analytics, or other purposes, for example, by an analytics engine 600 described with reference to FIG. 6.

Regardless of the sensor arrangement, sensor data from all parking lot sensors 26, for example, each parking space sensor 26, can be output to the special-purpose allocation computer 22, which can determine an overall occupancy rate of the entire lot from the collected sensor data. In some embodiments, the parking lot occupancy rate may be compared to a threshold value. This data can be used to determine how many spaces must be reserved. For example, the collected sensor data can be used to establish that 90% of the parking spots in a parking lot are currently occupied. This threshold value, i.e., 90%, may trigger a process where the special-purpose allocation computer 22 automatically increases or decreases a number of current spots marked as “reserve” spots. In some embodiments, the system may communicate with an analytics and/or cognitive learning computer, for example, an analytics engine 600 described with reference to FIG. 6, to predict how many reserved parking spaces 11 may be required based on traffic studies, etc.

The image projection device 24 may include a light source that outputs a predetermined image onto a ground or wall surface of a parking space 11. In some embodiments, each parking space 11 has an image projection device 24. In other embodiments, a single image projection device 24 projects an image, hologram, video, or other visual representation at each of a plurality of parking spaces 11, for example, to illustrate “painted lines” that distinguish parking spaces from each other. Referring again to FIG. 2, in some embodiments, the image projection device 24 is collocated with the sensor 26, which travel together along a rail 27, line, or the like to project an image onto a particular parking space of interest. In other embodiments, the projection device 24 is separate from the sensor 26 and can move independently of the sensor 26 which is stationary in each parking space 11, where the projection device 24 travels on a separate rail 27, line, or the like. In some embodiments, a plurality of different pre-recorded images are stored at a data storage device 36, for example, part of the allocation computer 22 or a remote database, and retrieved for output according to instruction data provided by the allocation computer 22. The projection device 24 may be constructed and arranged to emit the images onto a surface, or may include an electronic display or dynamic signage for displaying the desired images.

In some embodiments, the special-purpose allocation computer 22 is constructed and arranged to dynamically increasing or decreasing the number of handicap or other reserved parking spaces. Here, the special-purpose allocation computer 22 controls the projection device 24 to display or remove a handicap sign or other indicator that a particular parking space is reserved for a particular user or vehicle, or display or remove a color line that provides an outline of the allocated space 11, so on.

In some embodiments, the special-purpose authorization computer 23 is constructed and arranged to authenticate a user of a parking space allocated for handicapped persons, special users such as very important persons (VIPs), employees of the week, and so on by detecting and processing information related to machine-readable tags or handicap parking stickers 29 displayed on the vehicle itself or user of the vehicle. In some embodiments, the special-purpose authorization computer 23 communicates with the parking space sensors 26 to monitor vehicles, occupants, or other activity at or about a parking space 11.

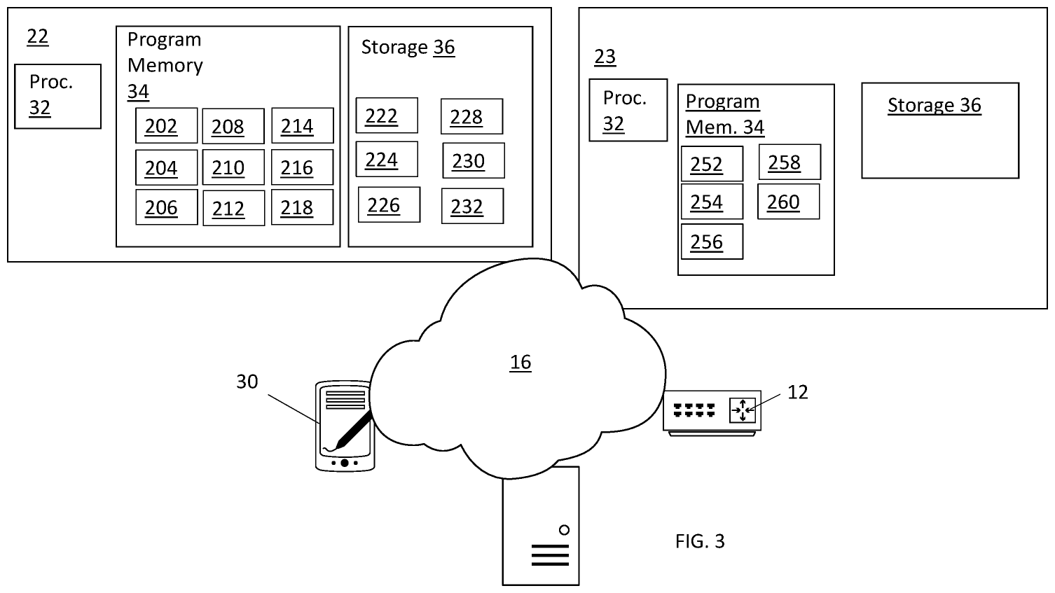

FIG. 3 illustrates computer software components of the special-purpose allocation computer 22 and the special-purpose authorization computer 23 shown and described in FIGS. 1 and 2. Each computer 22 and 23 includes at least one hardware computer processor 32, a memory 34 comprising a plurality of functionality modules, and a data storage 36. The processor(s) 32, memory 34, and/or data storage 36 of each computer 22, 23, may be the same or different. Each computer 22 and 23 may also include a user interface that may be displayed or otherwise accessible to allow the mobile device 30 or other user computer to create, view and edit the contents of the various modules, databases, or other data storage devices. A number of software functionality modules for implementing parking space management functions may be stored in the program memory 34 and executed by the processor 32 on the computer 23. A module may refer to a hardware based module, software based module, or a module comprising a combination of hardware and software. A module may be designed to implement or execute one or more particular functions or routines. The data storage 36 may include one or more databases or the like that store relevant data for performing parking management functions, in accordance with some embodiments. Such databases can be accessed by allocation computer 22 and/or authorization computer 23, by a remote computer over a network or by a remote computer over the Internet. Although a data storage 36 is shown as part of a computer, a data storage device 36 may in some embodiments be remote from the computer, for example, located in a cloud or other remote location, and in communication with the processor 32 and memory 34 via a network.

The functionality modules programmed at the special-purpose allocation computer 22 may be stored at the program memory 34 and may include but not be limited to an availability module 202, a modification module 204, an analytics module 206, a location module 208, a notification module 210, an anonymity module 212, mobile device interface 214, a reservation module 216, and a shopping list module 218.

The availability module 202 determines whether one or more parking spaces 11 are available for use by a vehicle. Parking space availability may be determined by one or more sensors 26 or other electronic detection devices at a parking space 11 detecting the physical presence of an object such as a vehicle, beach chair, pylon, etc. in the parking space 11. A sensor 26 may detect light, gas, radiation, sound, movement, and so on and provide data results from the detection to perform features and functions of the inventive concept. In some embodiments, the sensor 26 may be used to provide data to the availability module 202 and/or analytics module 206 to provide advanced analytics, for example, to distinguish objects in the parking space, for example, determine whether a vehicle or a pylon or person is currently occupying a parking space 11 of interest. The availability module 202 can also track a number of available spaces, by receiving sensor result data from multiple sensors 26 positioned throughout a predetermined region of a parking lot. For example, the availability module 202 may collect data from sensors, transducers, and/or other electronic devices constructed and arranged at a parking lot. The parking lot may have a particular arrangement, for example, a default array of parking spaces. The number of parking spaces in this array may change depending on determinations made by the allocation computer 22 regarding the need to increase or decrease of the number of handicapped spaces in the array based on supply, demand, vehicle preference, user status, and/or other preference-related reasons.

The modification module 204 generates and outputs instructions to the image projection device 24, which in turn displays a visual image at a ground or wall surface of a parking space 11. For example, the modification module 204 may send an instruction to the image projection device 24 to change a location of a displayed white line that forms a visual border between two adjacent parking spaces 11 so that the width of the parking space 11 is decreased to accommodate a motorcycle or scooter, or the increase the width of the parking space 11 to accommodate a large truck. In another example, the modification module 204 may receive a data request from other element of the allocation computer 22 or other remote computer to display an image of a handicap symbol on a ground or wall surface of a currently unmarked parking space 11 based on a determination that all other marked handicap spaces in the parking lot have been filled.

The analytics module 206 can analyze data received from the parking space sensors 26, stored data in the data storage device 36, navigation data and/or other data collected from remote computers to determine whether a vehicle is parked in a particular space 11, determine a number of occupants in the vehicle occupying the space 11, whether a parking space is wide enough to accommodate a vehicle that desires to occupy the parking space 11, whether the parking space 11 has been rented or otherwise paid for by communicating with a pay-for-parking computer system, and/or perform another occupancy-related determination. The analytics module 206 can output an analysis result to the modification module 204, which can control the image projection device 24, for example, to widen the lines, inactivate, dim, or otherwise shut off a light source that illuminates when in the space 11 is “reserved” for a particular user when the space 11 is occupied. In some embodiments, video analytics may be used to determine whether a vehicle is looking for a parking space. For example, a video camera in a parking lot may send images to the analytics module 206 of a same vehicle taken several minutes apart suggesting that the vehicle is circling the parking lot searching for an available parking space. In other example, the analytics module 206 may determine a type of vehicle, for example, that the vehicle is a motorcycle, which may be used to establish that a parking space 11 may be “partitioned” with a dividing line formed by a light emitted by the image projection device 24 that allows the space 11 to be used by two motorcycles instead of a single automobile.

The location module 208 collects and processes data related to a location of a vehicle relative to a parking space 11 of interest, for example, by communicating with the vehicle's navigation system, a vehicle operator's mobile phone global positioning satellite (GPS) device, or other location technology. In some embodiments, the location module 208 may communicate with the geofence device 12 or a WiFi triangulation system or the like, or a geofence module 258 of the authorization computer 23, to collect location data. This collected data may include a current distance between the vehicle and the parking space, which may be used to activate the image projection device 24 to illuminate a beacon, light signal, or other indicator to assist the driver with locating the parking space. In another example, the collected data may be used to automatically allocate a parking space 11 to a particular vehicle, for example, by activating a fence, barrier, or illuminated warning that prevents all other vehicles except for the particular vehicle from entering and occupying the parking space.

In some embodiments, the location module 208 collects and processes data related to a vehicle operator or passenger, who may be interested in shopping at a particular store, but the store may be too far away. For example, the vehicle operator or passenger may have a mobile device 30 that includes a GPS device and store-related software applications such as a shopping list, store preference data, and so on, which may be processed by the location module 208 and/or other modules such as the analytics module 206 to establish the distance from a store of interest, which can be used to determine which parking space(s) are of interest for reserving for the vehicle operator or passenger. A store computer 50 (see FIG. 6) may store item location information, for example, a physical location identified by aisle, row, shelf, etc., and can be accessed by the special-purpose allocation computer 22 and/or the special-purpose authorization computer 23 to determine a current distance between a parking space of interest and items on a shopping list, for example, stored on the mobile device 30 and configured for processing by the shopping list module 218 described below. The current location of the user may be determined by a geofence 13 or other location detection system detecting the mobile device 30 of the user.

The notification module 210 generates and outputs messages or other notifications to a user's mobile device 30 regarding parking space availability or related information. For example, the notification module 210 may communicate with a navigation device, for example, part of a store computer, a remote service, and so on, to send directions to an application executed at the mobile device 30, or to inform a user of an electric vehicle that a charging station is available at a particular space 11. In some embodiments, the notification module 210 may communicate with other computers to request that an event be performed. For example, the notification module 210 can output a data request to a store employee that a mobility scooter 15, wheelchair, golf cart, or other vehicle is needed at a particular handicap parking space 11.

The anonymity module 212 can receive and process data regarding the protection of anonymity of a vehicle occupant. For example, a vehicle occupant may desire to not be identified as handicapped or a person of status or privilege. In doing so, the anonymity module 212 can control the image projection device 24 to illuminate an image that provides anonymity, for example, that reserves a parking space 11 for a user, but is different than the well-known white handicap symbol against a blue background. In another example, the system 20 may establish that a government vehicle desires a particular parking space 11 but the image projection device 24 illuminates an innocuous image of a simple text “Reserved for license plate ABC123” identifying the vehicle's license plate but not identifying the vehicle as a government vehicle.

In some embodiments, the anonymity module 212 overrides a default image such as a white handicap symbol against a blue background when a determination is made that anonymity is desired, whereby a different image is illuminated at the parking space 11. In some embodiments, a mobile device 30 or other personal computer may be used to generate a request for anonymity that is received electronically by the anonymity module 212. In other embodiments, a sensor 26 may include an RFID reader located at or near the parking space 11 that collects data identifying the person as handicapped, for example, images of a person in a wheelchair. However, the anonymity module can be programmed to display images under conditions that anonymity is preserved for the user.

The reservation module 216 may communicate with a remote reservation system, one or more other functionality modules of the special-purpose allocation computer 22 and/or the special-purpose authorization computer 23 to reserve a particular parking space 11, for example, by controlling the image projection device 24 and/or barrier or other device that informs viewers of an occupancy state of a parking space 11. A remote reservation system may be used to allow vehicle users to request parking spaces in advance, for example, via a service offered by a retail establishment. The reservation module 216 may receive instructions from the reservation system to allocate particular parking spaces 11.

The shopping list module 218 may communicate with a remote reservation system, one or more other functionality modules of the special-purpose allocation computer 22 and/or the special-purpose authorization computer 23, and/or a user's mobile device 30 to collect shopping list data, which can be used to determine a preferable parking space 11 for a vehicle operator. For example, a user's mobile device 30 may store a listing of items that the vehicle operator plans to purchase at a store. The largest and bulkiest item on the list may be a lawnmower at a lawn and garden center. In this example, the system 20 can retrieve data that includes the identification of the lawnmower on the list, the location of the lawnmower in the store, and a location of the vehicle to determine parking spaces 11 that are separated from the lawnmower by a minimal distance. In another example, the length of the shopping list may be a factor. For example, a large shopping list containing many items of interest for purchase may establish a special status that elevates the user of the mobile device 30 storing the shopping list and provides privileges to the user, which may include the allocation of a parking space to the user's vehicle. In some embodiments, a processed shopping list can be used to determine a shortest walking path from the allocated parking space to a location where items on the shopping list may be acquired. For example, a customer may only have a pharmacy pickup which is determined to be 12 spaces away from one door, which may be preferable to a parking space 11 only 2 spaces away from a different door at a market end of the store. In some embodiments, a parking space 11 may be allocated to a vehicle based on the availability of a particular checkout counter. For example, the system can determine from cameras, point of sale data, analytics, and/or other information to establish that one region of the store proximal a parking space 11 may have a checkout line that is longer than a checkout counter further away from the parking space, whereby a different parking space may be automatically allocated.

The data storage 36 of the special-purpose allocation computer 22 may store but not be limited to a parking space availability database 222, a vehicle identification database 224, a parking spot parameters database 226, a user database 228, an image database 230, a surveillance image storage database 232. One or more of the functional modules may access one or more of the databases of the data storage 36 for performing functions of the parking space allocation system 20.

The parking space availability database 222 stores data regarding the parking spaces 11. The vehicle identification database 224 stores data relating to vehicles which are candidates for using the parking spaces 11 such as vehicle dimensions and so on. The parking spot parameters database 226 stores data relating to parking spot footprint, such as width, length, and so on, as well as adjustments made to the parking spaces 11, for example, a time stamp indicating that a parking space width was reduced by the illumination of a “painted line” that changes to accommodate a wider vehicle. The user database 228 stores data relating to vehicle occupants, for example, a status that a person is handicapped, a frequent shopper at the store, and so on. The image database 230 stores images that are retrieved for output by the image projection device 24 onto a parking lot surface, wall, or other location to identify the parking space 11. For example, images such as a well-known white handicap symbol against a blue background may be stored. In another example, data instructions may be stored for subsequent retrieval and use by the image projection device 24 for outputting an image of a white or color line that illuminates a ground surface of a parking space 11 so as to form two smaller parking spaces from a single space 11.

The surveillance image storage database 232 stores video and/or other data collected by a camera of the sensors 26. Unlike the image database 230, which stores pre-generated images, the surveillance image storage database 232 receives images captured in real-time or near real-time, for example, from monitors, cameras, and/or other sensors, which can be retrieved for analysis in accordance with embodiments herein.

As previously described, the special-purpose authorization computer 23 likewise includes at least one hardware computer processor 32, a memory 34 comprising a plurality of functionality modules, and a data storage 36.

The functionality modules programmed at the special-purpose authorization computer 23 may include but not be limited to a tag identification module 252, an analytics module 254, a mobile interface 256, a geofence module 258, and a registration module 260.

The tag identification module 252 collects and processes data regarding an identification code such as a vehicle sticker, electronic, mechanical, and/or visual tag, or the like that may be used to establish whether the vehicle is authorized to occupy a parking space 11, or otherwise include information concerning a parking event. For example, a sensor 26 such as a camera can capture an image of a vehicle identification number (VIN) displayed near a windshield of a vehicle and process and output the VIN to the tag identification module 252, which may determine whether there is a match with a listing of VINs stored in a vehicle identification database 224 of the allocation computer 22 or authorization computer 23. In some embodiments, a vehicle 15 may include a Bluetooth device or the like that outputs an identification of the vehicle 15 or otherwise communicate with the tag identification module 252.

The analytics module 254 may execute an advanced analytics process to authenticate a vehicle and/or its occupants. For example, a parking space 11 reserved for a handicapped user may initially be available for a particular vehicle, but may learn from analytics that the driver is not blind due to data collected by the sensors 26 from the vehicle, user, environment, and so on, stored information at local or remote databases, and/or other data sources such as a stored health history of the user, and subsequently display a warning that the vehicle is no longer permitted to use the space 11. In another example, the analytics module 254 can analyze data received from the parking space sensors 26 and/or other collected data that a vehicle is not permitted to use a parking space 11 because it is a different size than a vehicle authorized to be used. In some embodiments, the analytics module 254 of the authorization computer 23 and the analytics module 206 of the allocation computer 22 may share data, or otherwise perform similar or same analytics, and therefore, one of the allocation computer 22 and the authorization computer 23 may have an analytics module. In other embodiments, analytic operations may be performed by a computer externally from the allocation computer 22 and the authorization computer 23.

The geofence module 258 communicates with a geofence device 12, which includes a position sensing receiver incorporating GPS or RFID technology that provides a virtual geographic boundary, and generates a signal when the mobile device 30 enters a particular area about the parking spaces 11. When the vehicle is detected by the geofence device 12 as entering the virtual geographic boundary, information about the vehicle's location and/or other data can be captured and output to the authorization computer 23, which can be used to register the vehicle for a particular parking space 11.

The registration module 260 collects and processes data, for example, from an application executed at the mobile device 30, which allows the vehicle and/or user to register as warranting the use of a parking space. For example, a mobile device 30 may be configured with a special pass because the user is a frequent store shopper or recently received an award that provides the user with a parking space that is very close to the building. In some embodiments, such data is collected by the registration module 260, i.e., triggering activation, when a determination is made that the user has crossed or been intercepted by the geofence 13.

In some embodiments, the data storage 36 of the authorization computer 23 and the data storage 36 of the allocation computer 22 may store similar data, or otherwise perform similar or same analytics. In other embodiments, only one of the allocation computer 22 and the authorization computer 23 includes a data storage 36. In some embodiments, the data storage 36 of the authorization computer 23 includes authentication data, for example, vehicle and/or personal data that establishes permission for the vehicle to occupy one or more particular parking spaces 11. For example, data storage 36 of the authorization computer 23 may include a user database 228 and/or the image database 230 instead of the allocation computer data storage 36. In another example, the data storage 36 of the authorization computer 23 may store data related to a registered user such as handicap qualifications that can be retrieved when the user enters a geofence 13, whereby the sensors 26 are activated to collect authentication data such as images of the vehicle driver, license plate, and so on which can be compared to database contents to determine whether the vehicle and/or occupant(s) is authorized to use a predetermined parking space 11.

In some embodiments, a mobile application may allow the customer to register as a handicap parking space qualified and will register with the system upon crossing the geofence 13. Similarly, a smart car can communicate to the system once the destination is determined to be a particular location of interest, such as a retail store. Once in the parking lot, the mobile application can communicate directions to the assigned handicap parking space.

In some embodiments, a mobility cart 15 is pre-staged at a location 14 adjacent a handicap space according to a registered customer's needs, and can be delivered in a just in time manner. For example, when a vehicle is detected at a geofence 13, the system can determine according to embodiments herein whether an occupant is handicapped, and if so, a message can be sent to a store representative or a computer that identifies a wheelchair, golf, cart, or other mobility cart 15 for use by the user. The mobility cart 15 can be moved to a parking space 11 assigned for the user's vehicle.

In some embodiments, a charging station 17 and system may be provided to assign carts 15 based on a charge status, a length of a user's shopping list according to the shopping list module 218, and/or other factors. The charging station 17 may be a contactless charging station. The charging station 17 may be located at a separate location than the parking spaces 11 to charge a plurality of mobility carts 15.

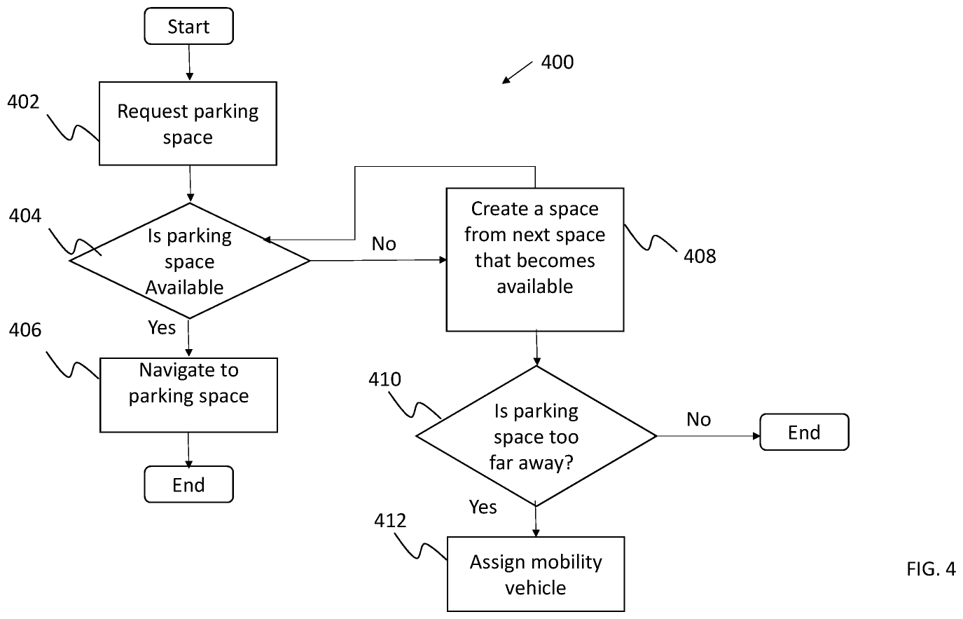

FIG. 4 depicts a flow diagram of a method 400 for allocating a parking space for a vehicle adjusting a number of parking spaces, in accordance with some embodiments. One embodiment of the method 400 may be implemented by incorporating some or all of the computing devices of FIGS. 1-3.

At step 402, a request is made by a phone application executed at a mobile device 30 sending a notification to the system to run a check to see if a space is available. The request can be made while a vehicle is enroute to a retail establishment having a parking lot arranged to include a plurality of parking spaces 11.

At decision diamond 404, a determination is made by the system 20 whether a parking space 11 is available for a vehicle. In some embodiments, the parking space 11 is a specific parking space of interest, for example, based on its proximity to a region of the retail establishment. If a determination is made that the request parking space 11 is available, then the method 400 proceeds to step 406, where a navigation system is activated to provide directions to the user, for example, displaying turn-by-turn instructions on the mobile device 30 using the mobile device GPS device for performing such navigation.

If at decision diamond 404, a determination is made that the request parking space 11 is not available, then the method 400 proceeds to step 408, where a neighboring or otherwise available parking space 11 is identified, for example, when the availability module 202 of the allocation computer 22 is executed. If at decision diamond 410 a determination is made that the parking space 11, and thus the vehicle occupying the space 11, is at a distance from a store location of interest greater than a threshold distance or if a parking space 11 cannot be allocated, then at step 412, a mobility vehicle 15 such as a golf cart, motorized wheelchair, scooter, or the like can be automatically assigned or allocated for use by the vehicle occupant in the parking space 11, or the mobility vehicle 15 can be provided to the user when no parking space 11 is available. The system can exchange data so that the mobility vehicle 15 arrives at the parking space 11 at or about the time that the vehicle arrives, for example, by the system sending instructions to the mobile device of a store associate who is responsible for providing access to users relying on motorized assistance to move about the store.

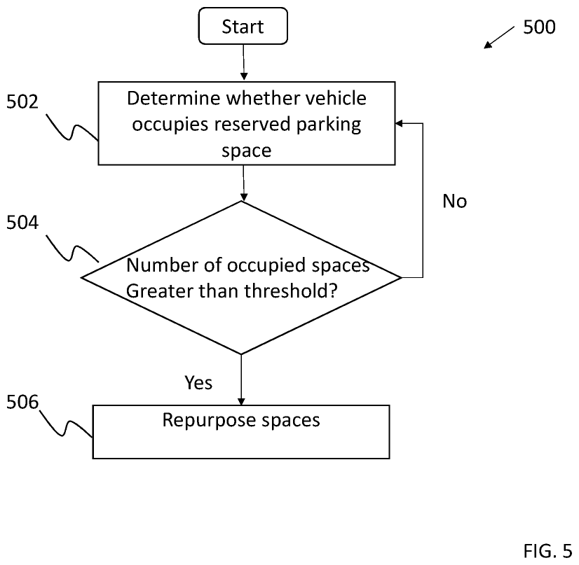

FIG. 5 depicts a flow diagram of a method 500 for adjusting a number of parking spaces, in accordance with some embodiments. One embodiment of the method 500 may be implemented by incorporating some or all of the computing devices of FIGS. 1-3.

At step 502, a determination is made whether a vehicle is occupying a parking space 11. In some embodiments, a combination of cameras or related sensors or monitors, video analytics, and the like are used. A data result is generated according to this determination, and stored at a database which can be aggregated with data results collected from other parking spaces to determine an occupancy percentage, or fullness, of a parking lot or predetermined region of the parking lot.

At decision diamond 504, a number of occupied parking spaces 11 are compared to a threshold value to determine the fullness of the parking lot. For example, if 90% of the parking spaces 11 in a predetermined region of the parking lot are determined to be occupied, then at step 506 at least one parking space 11 is repurposed. In some embodiments, the parking spaces 11 are repurposed by activating the allocation computer 22 to change the status of one or more parking spaces currently reserved for certain vehicles and unavailable for other vehicles. In other embodiments, an opposite step is performed, i.e., the parking spaces 11 are repurposed by activating the allocation computer 22 to change the status of one or more parking spaces currently available for all vehicles to be reserved for certain vehicles, such as those occupied by handicapped persons. In some embodiments, the authorization computer 23 is also activated to confirm the identity of the vehicle and/or occupants to determine if the vehicle is a candidate for occupying a currently unoccupied parking space. Here the allocation computer 22 can display an image of a symbol, message, or the like on the parking space 11 of interest that is commensurate with the type of authorized vehicle or occupant, such as a handicapped symbol, a message that includes the authorized vehicles license plate, or other identifier that associates that vehicle with that parking space. The display may direct an illumination of a surface of the parking space 11, an electronic display at a region of the parking space 11, or other manner of visual or audio display. In some embodiments, when a parking space is occupied, a message or indicator can be generated that informs other potential users that the parking space will revert to a handicap space after the present occupant leaves the parking space. Other examples may include fire lanes or other potential parking areas for vehicles, where a hologram of a pylon, yellow tape, fire lane notification, and so on may be illuminated depending on whether these areas are permissible for vehicles to be parked.

In some embodiments, a mobile application executed at the mobile device 30 can allow a customer to register as a qualified candidate for a handicap parking space. For example, when the vehicle crosses the geofence 13, the vehicle is automatically registered to receive a handicap or other reserved parking space. Similarly, a smart car or other vehicle with integrated wireless technology and computing features may communicate with the system after a retail store has been determined to be a destination of the vehicle, for example, using navigation features. Once the vehicle is in the store's parking lot, the mobile device 30 or smart car computer can exchange directions or other navigation-related details with the system with respect to the assigned parking space 11. In some embodiments, a mobility cart 15 or the like can be delivered to the spot at or about the same time as the anticipated arrival of the vehicle at the parking space 11.

In some embodiments where the allocation computer 22 is integrated with a navigation system of a vehicle, mobile device GPS, and so on, when the vehicle is enroute to a particular location having a parking lot, the mobile device 30 may include a feature, for example, embodied as executable program code, that outputs a notification from the mobile device 30 to the allocation computer 22, or a store computer or other remote computing device programmed to determine if a parking space is available in the parking lot. If not, then the allocation computer 22 can allocate a parking space neighboring the initial parking space of interest. Subsequently, the user can be navigated by the mobile device 30 or vehicle navigation system to the specific parking space allocated for the vehicle.

In some embodiments, a parking space 11 can be allocated by the system tracking a user's shopping trip. When one or more new parking spaces are 11 is needed, then an eligible space's shopper's trips can be queried, to determine who may depart the store before an identified handicapped person's arrival at the parking space 11. Here, a neighboring space may be allocated to the handicapped person's vehicle.

FIG. 6 is a block diagram of a system for determining handicap parking space availability, in accordance with some embodiments. In some embodiments, the parking space allocation system 20 of FIGS. 1-3 may incorporate a real-time analytics engine 600. In some embodiments, the analytics module 206 in FIGS. 1-3 may perform some or all analytics functions related to determining handicap parking space availability for a particular parking lot or other region where vehicles can be parked. A combination of historical data 602 regarding prior parking space use, current status data 604, and future parking space need data 606 can be retrieved to determine if a parking lot of interest has a number of unoccupied parking spaces that is at or greater than a threshold number of unoccupied parking spaces. In some embodiments, the real-time analytics engine 600 receives a combination of the historical data 602, current status data 604, and predicted further need data 606 to determine if a parking lot of interest has sufficient handicap spaces, and the analytics module 206 of the allocation computer 22 is configured to analyze data regarding a particular parking space 11, for example, analyze data received from parking space sensors 26, stored data in the data storage device 36, navigation data and/or other data collected from remote computers to determine whether a vehicle is parked in a particular space 11, determine a number of occupants in the vehicle occupying the space 11, whether a parking space is wide enough to accommodate a vehicle that desires to occupy the parking space 11, whether the parking space 11 has been rented or otherwise paid for by communicating with a pay-for-parking computer system, and/or perform another occupancy-related determination.

As shown in FIG. 6, the real-time analytics engine 600 generates a needs-based result, i.e., to establish from analytics data, artificial intelligence, cognitive learning systems, and so on if there are enough handicap parking spaces for a particular parking lot. In some embodiments, the real-time analytics engine 600 can exchange data, such as this result, with one or more of the allocation computer 22, authorization computer 23, an image projection device 24, sensors 26, and/or other electronic devices described with respect to FIGS. 1-5.

The historical data 602 can be stored at and retrieved from a data repository such as a database at a local or remote computer, for example, store computer 50, and in communication with the analytics engine 600 via remote computer over a network 16, for example, located in a cloud or other remote location, and in communication with the processor 32 and memory 34 via a network 16. In some embodiments, access is by scripting the desired service calls and data transfers available through an application programming interface (API) between the analytics engine 600 and the data repository, for example, programmed routine executed by hardware server to which the data repository is part of that receives callable services or the like.

The historical data 602 may include but not be limited to information regarding previous parking space use, for example, prior disable spot usage, dates and times of usage, length of time of occupancy of a parking space, length of time of a shopping trip by a customer using a parking space, and so on. This historical data 602 may be collected by human observation, electronic sensing, or a combination of both, then subsequently stored. In some embodiments, sensors, video analytics, and/or other technology that can capture the abovementioned information can operate to collect both the historical data 602 and the current status data 604.

The real-time analytics engine 600 may receive current status data 604 and/or future need data 606 regarding a request for the availability of parking spaces. In some embodiments, current status data 604 and/or future need data 606 are generated from a computer-executed algorithm (not shown) that determines if additional parking spaces are needed. For example, an algorithm can establish that currently one parking space is available and additional spaces are required because it is known that this is a popular time for disabled shoppers to shop. In some embodiments, current status data 604 and/or future need data 606 are generated from a user request made via a computer, for example, a user typing the request. In some embodiments, current status data 604 and/or future need data 606 may be collected by human observation, electronic sensing, or a combination of both. In some embodiments, the analytics engine 600 automatically generates current status data 604 and/or future need data 606 from the historical data 602. For example, the analytics engine 600 can determine that a predetermined block of parking spaces are to be reserved for handicap users when historical data 602 establishes that disabled military veterans congregate at the parking lot every Veteran's Day.

In some embodiments, the real-time analytics engine 600 outputs a result to an allocation system 22, for example, described with respect to FIGS. 1-3. The result may be part of an electronic data output used for identifying parking spaces as handicap or reserve spaces, or conversely, used for removing a handicap or reserve status. The allocation system 22 in response can automatically increase or decrease a number of current spots marked as “handicap spots.” In some embodiments, the analytics engine result can be processed by the store computer 50 or allocation computer 22 to determine whether to close a parking lot, or render inaccessible predetermined parking spaces of the parking lot when a previously estimated number of disabled shoppers is determined to be in accurate. For example, a parking lot may have a gate at its entrance(s) that is automatically closed in response to a received signal directly from the real-time analytics engine 600, or received from the allocation computer 22 or store computer when a determination is made that a parking lot is at capacity, or exceeds a threshold of handicap parking spaces, or other predetermined criteria.

In some embodiments, the real-time analytics engine 600 outputs a result to a store computer 50, which in turn can process the result to establish whether certain spaces are to be reserved as handicapped, reserved, and so on. The store computer 50 may include a store history to establish a time when additional handicap spaces are needed. The store computer 50 in turn can exchange communication data with the allocation computer 22. The allocation computer 22 in turn can control sensors, e.g., a camera, monitors, and so on, to validate the occupancy of parking spaces. The store computer 50 may include store history information that is used by the system to override a previous determination by the analytics engine 600 regarding occupancy and whether to designate specific parking spaces or general regions of a parking lot for allocating parking spaces. Accordingly, the real-time analytics engine 600, like the parking space allocation system, is constructed and arranged to scale to the size of the parking lot being monitored.

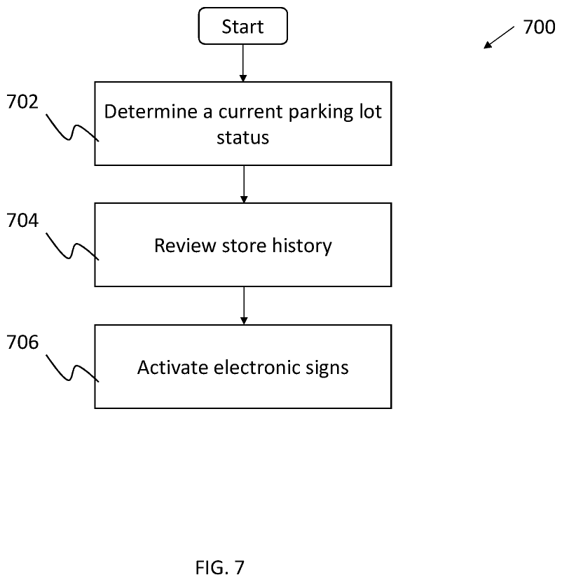

FIG. 7 depicts a flow diagram of a method 700 for predicting a parking space requirement, in accordance with some embodiments. Some embodiments of the method 700 may be implemented by incorporating some or all of the computing devices of FIGS. 1-3 and/or 6.

At step 702, a parking lot status is determined, for example, automatically by the parking space allocation system 20 of FIGS. 1-5 or manually by an observer. A parking lot status may include an occupancy status, for example, over 90% of parking lot spaces are occupied, 3 of 4 handicap spaces are occupied, and so on.

At step 704, a store history is reviewed. Another embodiment may include one or more algorithms executed by a special-purpose computer 22 to determine if one or more handicap parking spaces are needed. The algorithms may receive as inputs an output of the analytics engine 600 described in FIG. 6. For example, it is currently 3 p.m. on Thursday, the parking lot is 90% occupied, and the store history reveals that disabled people tend to shop at this time.

At step 706, if a determination is made that additional parking spaces are required, the system 20 can signal electronic signs in the parking lot to switch to a disabled parking sign if empty, or switch to disabled once the current automobile occupying that space pulls out. For example, an indicator such as the image projection device 24, electronic sign, and so on with respect to FIGS. 1-5 may be activated, and more specifically, the analytics system 600 can determine an occupancy status of the parking lot of interest, compare the occupancy status to a history of occupancy of the parking lot of interest according to predetermined criteria, and activate the indicator 24 in response to a determination from the comparison that additional parking spaces are required to increase the number of unoccupied parking spaces to be at or greater than a threshold number of unoccupied parking spaces, for example, a user-defined value of 10 parking spaces. In some embodiments, vision intelligence technology may be implemented to identify handicap hang tags extending from a rearview mirror or positioned at windshield, identify license plates, capture video or images of vehicles of store customers entering and leaving the parking lot, and so on, to determine the need for additional parking spaces.

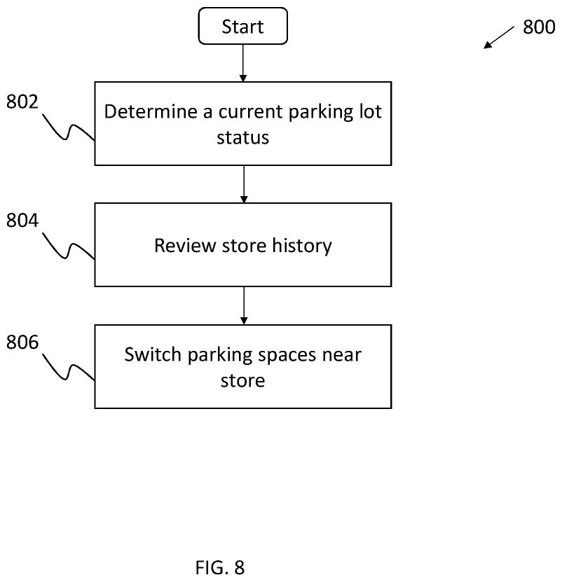

FIG. 8 depicts a flow diagram of a method 800 for allocating parking space for a vehicle, in accordance with some embodiments. Some embodiments of the method 700 may be implemented by incorporating some or all of the computing devices of FIGS. 1-3 and/or FIG. 6.

At step 802, a parking lot status is determined. Step 802 may be similar to or the same as step 702 of FIG. 7. Details are therefore omitted for brevity.

At step 804, a store history is reviewed. Step 804 may be similar to or the same as step 804 of FIG. 7. Details are therefore omitted for brevity.

At step 806, the system can switch spots that are closer to the store in another aisle if required or requested, by processing sensor data. Vision Intelligence, radar technology, weight sensors, and so on can be present to determine that a parking space is unoccupied and available for reassignment.

A number of implementations have been described. Nevertheless, it will be understood that the foregoing description is intended to illustrate, and not to limit, the scope of the inventive concepts which are defined by the scope of the claims. Other examples are within the scope of the following claims.

What is claimed is:

1. A parking space allocation system, comprising:
a special-purpose allocation computer that communicates with at least one electronic sensor to identify a state of a plurality of parking spaces, including a determination whether the parking spaces are occupied or unoccupied;
a light emitting device that is controlled by the special-purpose allocation computer to automatically modify an unoccupied parking space to be visually identifiable for authorized use by a vehicle or vehicle occupant; and
a special-purpose authorization computer that authenticates the vehicle or vehicle occupant for the authorized use of the unoccupied parking space by the vehicle, wherein the special-purpose allocation computer further generates and outputs a signal that changes a state of the parking spaces by allocating the unoccupied parking space to the authenticated vehicle or vehicle occupant according to a predetermined criterion that requires the unoccupied parking space to be in proximity to or a predetermined distance from a destination of interest.

2. The system of claim 1, wherein the special-purpose allocation computer communicates with an image projection device to the state of a non-handicap parking space to a handicap parking space to illuminate a surface of the parking space with a handicap symbol.

3. The system of claim 1, wherein at least one of the special-purpose allocation computer or the special-purpose authorization computer comprises an analytics module that determines whether the vehicle or vehicle occupant is authorized to occupy the parking space or to identify a vehicle for occupying the parking space.

4. The system of claim 1, further comprising a reservation system that reserves at least one of the parking spaces.

5. The system of claim 1, further comprising a navigation system that directs a driver of the vehicle to an available handicap parking space.

6. The system of claim 1, wherein the special-purpose allocation computer allocates a non-handicap parking space to a non-handicapped shopper and automatically changes the non-handicap parking space to a handicap parking space when the system estimates that a tracked non-handicapped person will leave the parking space before a handicapped person's arrival.

7. The system of claim 1, wherein the special-purpose allocation computer determines a percentage of occupancy of reserved parking spaces, and determines that when a percentage of occupancy is at a threshold value, changes a neighboring parking space from a non-handicap parking space to a handicap parking space.

8. A parking space allocation system, comprising:
a plurality of electronic sensors that monitor a plurality of parking spaces to determine an occupancy of at least one of the parking spaces;
an image projection device that changes a state of the at least one of the parking spaces to a reserved state for use by a predetermined vehicle; and
a special-purpose allocation computer that controls the image projection device to change the state of the at least one of the parking spaces by determining a match between the predetermined vehicle and a location of the parking space and by determining whether an occupancy percentage of the plurality of parking spaces is greater than a threshold value.

9. The system of claim 8, further comprising a special-purpose authorization computer that authenticates the predetermined vehicle or an occupant of the vehicle for the use of the unoccupied parking space by the vehicle, wherein the special-purpose allocation computer further generates and outputs a signal that changes a state of the parking spaces by allocating the unoccupied parking space to the authenticated vehicle or vehicle occupant according to a predetermined criterion that requires the unoccupied parking space to be in proximity to or a predetermined distance from a destination of interest.

10. The system of claim 9, wherein at least one of the special-purpose allocation computer or the special-purpose authorization computer comprises an analytics module that determines whether the vehicle or vehicle occupant is authorized to occupy the parking space or to identify a vehicle for occupying the parking space.

11. The system of claim 8, further comprising a reservation system that reserves at least one of the parking spaces.

12. The system of claim 8, further comprising a navigation system that directs a driver of the vehicle to an available handicap parking space.

13. The system of claim 8, wherein the special-purpose allocation computer allocates a non-handicap parking space to a non-handicapped shopper and automatically changes the non-handicap parking space to a handicap parking space when the system estimates that a tracked non-handicapped person will leave the parking space before a handicapped person's arrival.

14. The system of claim 8, wherein the special-purpose allocation computer determines a percentage of occupancy of reserved parking spaces, and determines that when a percentage of occupancy is at a threshold value, changes a neighboring parking space from a non-handicap parking space to a handicap parking space.

15. A parking space analytics system, comprising:
a special-purpose computer processor that processes a combination of historical data regarding prior parking space use, current status data, and future parking space need data to determine if a parking lot of interest has a number of unoccupied parking spaces that is at or greater than a threshold number of unoccupied parking spaces; and
a special-purpose allocation computer that controls an indicator at the unoccupied parking spaces in response to a result generated by the special-purpose computer processor of the processed combination of historical data, current status data, and future parking space need data to automatically modify unoccupied parking spaces to be visually identifiable for authorized use by a vehicle or vehicle occupant.

16. The parking space analytics system of claim 15, wherein the indicator includes an electronic sign, and wherein the special-purpose computer processor determines an occupancy status of the parking lot of interest, compares the occupancy status to a history of occupancy of the parking lot of interest according to predetermined criteria, and activates the electronic sign in response to a determination from the comparison that additional parking spaces are required to increase the number of unoccupied parking spaces to be at or greater than the threshold number of unoccupied parking spaces.

17. The parking space analytics system of claim 15, wherein the special-purpose computer processor determines an occupancy status of the parking lot of interest, compares the occupancy status to a history of occupancy of the parking lot of interest according to predetermined criteria, and changes an occupancy state of one or more predetermined parking spaces according to a determination of store activity at a region of a retail establishment proximal the predetermined parking spaces.
